(19) United States
(12) Patent Application Publication
(10) Pub. No.: US 2026/0180348 A1
(43) Pub. Date: Jun. 25, 2026

(54) POWER CONTROL DEVICE AND METHOD FOR CONTROLLING DC-DC CONVERTER

(71) Applicant: LG ENERGY SOLUTION, LTD., Seoul (KR)

(72) Inventor: Mi So PARK, Daejeon (KR)

(73) Assignee: LG ENERGY SOLUTION, LTD., Seoul (KR)

(21) Appl. No.: 18/854,876

(22) PCT Filed: Sep. 15, 2023
(86) PCT No.: PCT/KR2023/013941

§ 371 Date: Oct. 7, 2024

(30) Foreign Application Priority Data
Sep. 16, 2022 (KR) 10-2022-0116817
Sep. 15, 2023 (KR) 10-2023-0122905

(51) Int. Cl. H02J 7/64; H02J 3/001; H02J 3/32; H02J 3/388; H02J 7/90; H02J 105/12; H02M 1/14

(52) U.S. Cl. CPC H02J 7/64; H02J 3/00125; H02J 3/32; H02J 3/388; H02J 7/933; H02M 1/14; H02J 2105/12; H02J 2207/20

(57) ABSTRACT

Discussed is a power control apparatus and a power control method. The power control apparatus may monitor an output power of a power conversion system (PCS), detect changes in a voltage of a DC link, and control output power of a battery by comparing the output power of the PCS with a rated power of the battery, and thus, provides stabilization of an energy storage system by preventing voltage fluctuations in the DC link.

### CROSS REFERENCE TO RELATED APPLICATIONS

This application claims priority to and the benefit of Korean Patent Application No. 10-2022-0116817 filed in the Korean Intellectual Property Office on Sep. 16, 2022 and Korean Patent Application No. 10-2023-0122905 filed in the Korean Intellectual Property Office on Sep. 15, 2023, the entire contents of which are incorporated herein by reference.

### TECHNICAL FIELD

The present invention relates to a power control apparatus and method for controlling a DC/DC converter, and more particularly, to a power control apparatus and method for controlling output of a battery using a DC-DC converter to stabilize the voltage of a DC link.

### BACKGROUND ART

An energy storage system relates to renewable energy, a battery that stores electric power, and the power grid. Recently, as the spread of smart grid and renewable energy is expanding and the efficiency and the stability of the power system are emphasized, a demand for energy storage systems in home for power supply and demand control and power quality improvement is increasing. Generally, the output and capacity of home energy storage systems vary depending on purpose of use.

For example, a home energy storage system is applied with a solar power system (Photo Voltaic; PV) and may include a battery section consisting of multiple batteries, a battery management system (BMS) for battery management, a power conversion system (PCS), an energy management system (EMS), and a DC/DC converter, etc.

Meanwhile, in a home energy storage system, when power consumption in a load exceeds a rated power, the PCS may be discharged to stabilize the load. Accordingly, the voltage of the DC link unit may temporarily fluctuate, thereby resulting in ripple.

Generally, home energy storage systems stabilize the DC link by sending ripple current into the grid direction when ripple occurs in the DC link.

However, when a power outage occurs that limits use of the grid, the home energy storage system cannot flow ripple current into the direction of the grid, which has the disadvantage of reducing power efficiency delivered to the load.

In addition, when a user starts using a load in a power outage situation, a high peak voltage that temporarily exceeds an appropriate range may be generated in the DC link. Accordingly, the PCS and multiple batteries in a conventional home energy storage system have the disadvantage of being shut down to prevent failure due to overvoltage.

### DETAILED DESCRIPTION OF THE INVENTION

### Technical Problem

To obviate one or more problems of the related art, embodiments of the present disclosure provide a power control apparatus controlling a DC/DC converter.

To obviate one or more problems of the related art, embodiments of the present disclosure also provide a power control method controlling a DC/DC converter.

To obviate one or more problems of the related art, embodiments of the present disclosure provide an energy storage system including a power control apparatus configured to control a DC/DC converter.

### Technical Solution

In order to achieve the objective of the present disclosure, an power control apparatus, which is connected to a converter performing Direct current/Direct current (DC/DC) conversion between a battery and a power conversion system (PCS), may include a memory and a processor executing at least one instruction in the memory, and the at least one instruction may include an instruction to detect a voltage of DC link between an input terminal of the PCS and an output terminal of the converter; and an instruction to control the output power of the battery based on a change in output power of the PCS which in turn is in accordance with a change in the voltage of DC link.

Here, the instruction to control the output power of the battery may include an instruction to control the output power of the battery by controlling a current of the battery.

In addition, the instruction to control the output power of the battery may include an instruction to control the battery to output power with a predefined peak power value when the output power of the PCS exceeds the output power of the battery.

Here, the instruction to control the battery to output power with the predefined peak power value may include an instruction to, upon a peak power output period of the battery being equal to or longer than a predefined first period of time, compare a difference between the output power of the PCS and the output power of the battery with a predefined threshold value; and an instruction to control the battery to output power at rated power in the instance the difference is less the predefined threshold value.

Meanwhile, the instruction to control the battery to output power with the predefined peak power value may include an instruction to, upon a peak power output period of the battery being equal to or longer than predefined first period of time, compare difference between the output power of the PCS and the output power of the battery with a predefined threshold value; and an instruction to control the battery to output power stepwise to a rated power in an instance the difference is greater than or equal to the predefined threshold value.

Here, the instruction to control the battery to output power stepwise to the rated power may include an instruction to control the battery to output power by reducing the output power amount stepwise by the threshold power amount during a predetermined second period of time based on a peak power of the battery.

In addition, the instruction to control the battery to output power stepwise to the rated power may further include an instruction to control the battery to output power at the rated power when the peak power output period exceeds the predefined second period of time.

According to another embodiment of the present disclosure, a power control method performed by a power control apparatus, which is connected to a converter performing Direct current/Direct current (DC/DC) conversion between a battery and a power conversion system (PCS) and configured to control output power of the battery, may include detecting a voltage of DC link between an input terminal of the PCS and an output terminal of the converter; and controlling the output power of the battery based on a change in output power of the PCS which in turn is in accordance with a change in the voltage of DC link.

The controlling the output power of the battery may include controlling the output power of the battery by controlling a current of the battery.

The controlling the output power of the battery may include controlling the battery to output power with a predefined peak power value when the output power of the PCS exceeds a predefined rated power of the battery.

The controlling the battery to output power with the predefined peak power value may include, upon a peak power output period of the battery being equal to or longer than a predefined first period of time, comparing a difference between the output power of the PCS and the output power of the battery with a predefined threshold value; and controlling the battery to output power at rated power in an instance the difference is less the predefined threshold value.

The controlling the battery to output power with the predefined peak power value may include, upon a peak power output period of the battery being equal to or longer than a predefined first period of time, comparing a difference between the output power of the PCS and the output power of the battery with a predefined threshold power amount; and controlling the battery to output power stepwise to a rated power in an instance the difference is greater than or equal to the predefined threshold value.

The controlling the battery to output power stepwise to the rated power may include controlling the battery to output power by reducing the output power amount stepwise by the threshold power amount during a predetermined second period of time based on a peak power of the battery.

The controlling the battery to output power stepwise to the rated power may include controlling the battery to output power at the rated power when the peak power output period exceeds the predefined second period of time.

According to another embodiment of the present disclosure, an energy storage e system may include a battery rack; a plurality of converters configured to perform Direct current/Direct current (DC/DC) conversion in conjunction with the battery rack; a power conversion system (PCS) connected to the DC/DC converter and a load; and a power control apparatus connected to the DC/DC converter and configured to control an operation of the DC/DC converter, wherein the plurality of converters are operated by the power control apparatus which is configured to detect a voltage of a DC link between an input terminal of the PCS and an output terminal of the converter and to control output power of the battery based on a change in output power of the PCS which in turn is in accordance with a change in the voltage of the DC link.

The plurality of converters may be operated, by the power control apparatus, to control the output power of the battery by controlling a current of the battery.

The plurality of converters may be operated, by the power control apparatus, to control the battery to output power with a predefined peak power value when the output power of the PCS exceeds a predefined rated power of the battery.

The plurality of converters may be operated, by the power control apparatus, to: upon a peak power output period of the battery being equal to or longer than a predefined first period of time and a difference between the output power of the PCS and a rated power of the battery being less than the predefined threshold value, control the battery to output power at the rated power.

The plurality of converters are operated, by the power control apparatus, upon a peak power output period of the battery being equal to or longer than a predefined first period of time and a difference between the output power of the PCS and a rated power of the battery being equal to or greater or the predefined threshold value, to control the battery to output power stepwise to the rated power.

The plurality of converters are operated, by the power control apparatus, to control the battery to output power by reducing the output power amount stepwise by the threshold power amount during a predetermined second period of time based on the peak power of the battery.

The plurality of converters are operated, by the power control apparatus, to control the battery to output power at the rated power when the peak power output period exceeds the predefined second period of time.

### Advantageous Effects

The power control apparatus and method according to embodiments of the present invention may monitor the output power of the PCS, detect changes in the voltage of the DC link, and control the output power of f the battery by comparing the output power of the PCS with the rated power of the battery, and thus, provides stabilization of the energy storage system by preventing voltage fluctuations in the DC link.

### BRIEF DESCRIPTION OF THE DRAWINGS

FIG. 1 is a block diagram of an energy storage system to which the present invention may be applied.

FIG. 2 is a block diagram of an energy storage system in a power outage situation.

FIG. 3 is a block diagram of a power control apparatus according to embodiments of the present invention.

FIG. 4 is a flowchart of a power control method according to embodiments of the present invention.

FIG. 5 is a flowchart for explaining the step of controlling the output power of the battery in the power control method according to embodiments of the present invention.

FIG. 6 is a block diagram for explaining a power control method according to embodiments of the present invention.

FIG. 7 is a graph of voltage change over time in the DC link according to FIG. 6.

FIG. 8 is a flowchart to explain the step of controlling the output power of the battery stepwise in the power control method according to embodiments of the present invention.

FIG. 9 is a graph of battery output power control over time according to FIG. 8

FIG. 10 is a block diagram for explaining a power control method according to another embodiment of the present invention.

FIG. 11 is a graph of voltage change over time in the DC link according to FIG. 10.

### BEST MODES FOR PRACTICING THE DISCLOSURE

The present invention may be modified in various forms and have various embodiments, and specific embodiments thereof are shown by way of example in the drawings and will be described 1 in detail below. It should be understood, however, that there is no intent to limit the present invention to the specific embodiments, but on the contrary, the present invention is to cover all modifications, equivalents, and alternatives falling within the spirit and technical scope of the present invention. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes combinations of a plurality of associated listed items or any of the plurality of associated listed items.

It will be understood that when an element is referred to as being “coupled” or “connected” to another element, it can be directly coupled or connected to the other element or an intervening element may be present. In contrast, when an element is referred to as being “directly coupled” or “directly connected” to another element, there is no intervening element present.

The terms used herein is for the purpose of describing specific embodiments only and are not intended to limit the present invention. As used herein, the singular forms “a”, “an” and “the” are intended to include the plural forms as well, unless the context clearly indicates otherwise. It will be further understood that the terms “comprises”, “comprising”, “includes”, “including” and/or “having”, when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

Unless otherwise defined, all terms used herein, including technical and scientific terms, have the same meanings as commonly understood by one skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Hereinafter, exemplary embodiments of the present invention will be described in detail with reference to the accompanying drawings.

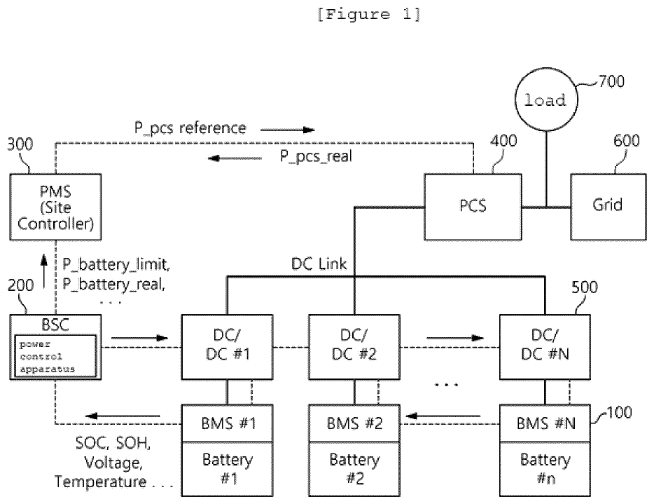

FIG. 1 is a block diagram of an energy storage system to which the present invention may be applied,

Referring to FIG. 1, a basic unit of a battery that stores power in an energy storage system is typically a battery cell. A series/parallel combination of battery cells may form a battery pack and multiple battery packs may form a battery rack. In other words, a battery rack may be a basic unit of a battery system by combining battery packs in series/parallel. Here, the battery pack may be referred to as a battery module, depending on a device or system in which the battery is used. For example, battery #1, battery #2, . . . , and battery #N shown in FIG. 1 may be in the form of a battery pack or battery rack.

Here, a battery management system (BMS) 100 may be installed for each battery. The BMS 100 may monitor a current, a voltage and a temperature of each battery pack (or rack) to be managed, calculate a state of charge (SOC) of the battery based on a monitoring result to control charging and discharging.

Meanwhile, a battery system controller (BSC) may be located in each battery section which includes a plurality of batteries, peripheral circuits, and devices. The battery system controller 200 may monitor and control objects such as a voltage, a current, a temperature, and a circuit breaker in the battery section. In addition, the BSC 200 may calculate output of each DC-DC converter based on state information of monitored batteries and deliver it to at least one DC-DC converter.

In addition, a power conversion system (PCS) 400 installed in each battery section may control power supplied from the outside and power supplied from the battery section to the outside, thereby controlling charging and discharging of the battery. The power conversion system may include a DC/AC inverter.

Furthermore, the output of the DC/DC converter 500 may be connected to the PCS 400 and the PCS 400 may be connected to the power grid 600 and the load 700. Here, the PCS 400 typically operates in constant power mode. A power management system (PMS) 300 connected to the PCS may control the output of the PCS based on the monitoring and control results of the battery management system or the battery system controller.

In the energy storage system of FIG. 1, battery #1 is connected to DC/DC converter #1, battery #2 is connected to DC/DC converter #2, and battery #N is connected to DC/DC #N. The output of the DC/DC converter corresponding to each battery is connected to the PCS 400 through a DC link.

The DC/DC converter may be a bidirectional converter, wherein when conversion is performed from the battery to the load direction, the input of the DC/DC converter is connected to a battery (a battery cell, a battery pack (module), or a battery rack) and the output of the DC/DC converter may be connected to the load. As examples of the DC/DC converter, various types of converters such as a full-bridge converter, a half-bridge converter, and a flyback converter may be used.

Meanwhile, communication among the BMS 100, the BSC 200, the PMS 300, and the PCS 400 may be implemented through a controller area network (CAN) or Ethernet (indicated by a dotted line in FIG. 1).

In such an energy storage system, a central controller within the system may generally calculate an output value of the battery at every moment and transmit the calculated value as a command to each battery (higher level control). However, higher-level control is possible only when the system voltage of the energy storage system is maintained, that is, lower-level control is preceded.

Meanwhile, the DC link, which is the area between the DC/DC converter and the PCS, has a DC voltage and the voltage of the DC link may generally be called a system voltage.

The voltage of the DC link needs to be maintained at a constant level for stability of the entire energy storage system,

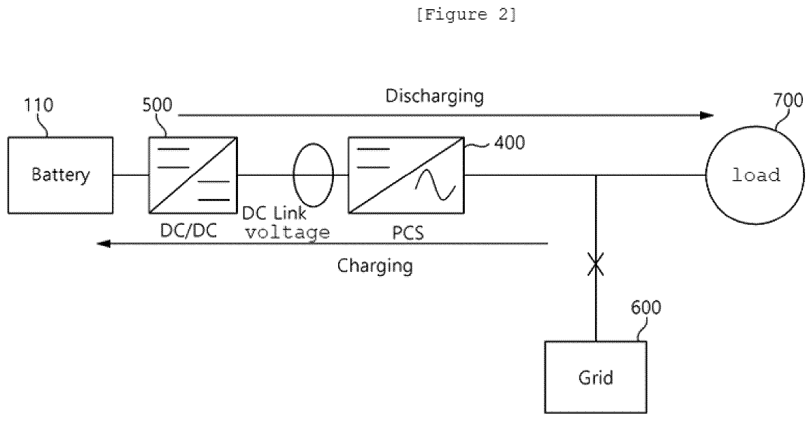

FIG. 2 is a block diagram of an energy storage system in a power outage situation.

Referring to FIG. 2, the power control apparatus according to embodiments of the present invention, as described above, may control the DC/DC converter (500) to maintain the voltage of the DC link, which is the system voltage, in a constant state.

In general, when power consumption occurs in the load 700, the PCS 400 may output power equal to the size of the output reference (power value to be output by the PCS) calculated by the PMS 300 in FIG. 1. Here, the DC voltage on the DC link may temporarily fluctuate, resulting in ripple voltage. Accordingly, the PCS 400 may controls the size of the output power so that the size of the ripple voltage of the DC link is generated within an appropriate range.

In addition, when power consumption exceeding rated power is generated from the load 700, the voltage of the DC link may also fluctuate. Accordingly, the PCS 400 may receive additional power from the grid 600 or output power into the direction of the grid 600 to control the ripple voltage in the DC link to be maintained within an appropriate range.

However, use of the grid 600 may be restricted when a power outage occurs, so the PCS 400 cannot receive power from the grid 600 and cannot send ripple voltage toward the grid 600. Thus, the power efficiency of the energy storage system may be reduced due to the ripple voltage.

Additionally, in a power outage situation, if the load is operated without notice by a user, a high peak voltage that temporarily exceeds an appropriate range may be generated in the DC link. Accordingly, each of the PCS 400 and the battery 500 may shut down its operation through a protection circuit to prevent failure due to the peak voltage.

Accordingly, the power control apparatus according to embodiments of the present invention may use the DC/DC converter 500 to control the output of the battery 110, separately from the output control of the PCS 400, and thus, when a power outage situation in which use of the grid is stopped occurs, the output power of the battery 110 is output at peak power, so that the control burden on the PCS 400 can be reduced even when the load is operated without notice by a user.

In addition, the power control apparatus can increase efficiency of the energy storage system by preventing system interruption due to excessive ripple voltage in the DC link.

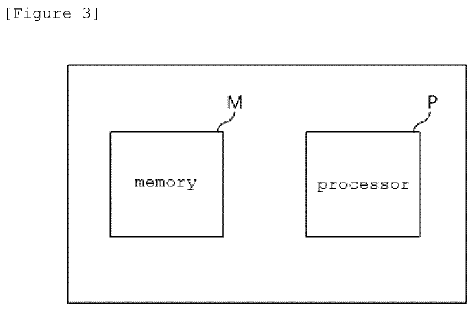

FIG. 3 is a block diagram of a power control apparatus according to embodiments of the present invention.

Referring to FIG. 3, the power control apparatus according to embodiments of the present invention may be provided as a component within the battery system controller (BSC) 200 of FIG. 1, or may be provided as a separate, independent component.

According to an embodiment, the power control apparatus may monitor output power of the PCS 400 and detect a change in the voltage of the DC link according to operation of the load 700.

Additionally, the power control apparatus may be connected to a DC/DC converter 500. Accordingly, the power control apparatus may control the DC/DC converter 500 so that output power of a battery 110 is controlled according to the voltage change of the DC link.

Meanwhile, the power control apparatus may include a memory (M) and a processor (P).

According to an embodiment, the memory M may include at least one of a volatile storage medium and a non-volatile storage medium. For example, the memory M may include at least one of read only memory (ROM) and random access memory (RAM).

The memory M may include at least one instruction executed by the processor P.

According to embodiments, the at least one instruction may include an instruction to detect a voltage of DC link between an input terminal of the PCS and an output terminal of the converter; and an instruction to control the output power of the battery based on a change in output power of the PCS which is in accordance with a change in the voltage of DC link.

Here, the instruction to control the output power of the battery may include an instruction to control the output power of the battery by controlling current of the battery.

In addition, the instruction to control the output power of the battery may include an instruction to control the battery to output power with a predefined peak power value when the output power of the PCS exceeds the output power of the battery.

Here, the instruction to control the battery to output power with the predefined peak power value may include an instruction to, upon a peak power output period of the battery being equal to or longer than a predefined first period of time, compare difference between the output power of the PCS and the output power of the battery with a predefined threshold value; and an instruction to control the battery to output power at rated power in the instance that the difference is less the predefined threshold value.

Meanwhile, the instruction to control the battery to output power with the predefined peak power value may include an instruction to, upon a peak power output period of the battery being equal to or longer than a predefined first period of time, compare difference between the output power of the PCS and the output power of the battery with a predefined threshold value; and an instruction to control the battery to output power stepwise to rated power in the instance that the difference is greater than or equal to the predefined threshold value.

Here, the instruction to control the battery to output power stepwise to rated power may include an instruction to control the battery to output power by stepwise reducing a threshold power amount during a predetermined second period of time based on the peak power of the battery.

In addition, the instruction to control the battery to output power stepwise to rated power may further include an instruction to control the battery to output power at rated power when the peak power output period exceeds the predefined second period of time.

Hereinafter, a power control method according to the operation of the processor P of the power control apparatus will be described in detail.

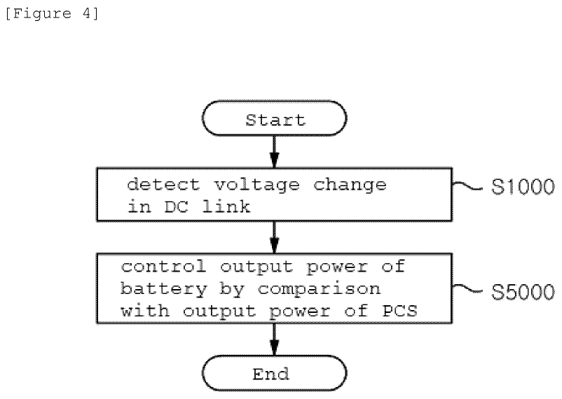

FIG. 4 is a flowchart of a power control method according to embodiments of the present invention.

Referring to FIG. 4, the power control apparatus according to embodiments of the present invention may detect a voltage change in the DC link (S1000). Here, the DC link may be an area between an input terminal of the PCS (400) and an output terminal of the DC/DC converter (500).

A voltage change of the DC link in a power outage situation may occur depending on output power of the battery 110 and operation timing of the load 700.

According to an embodiment, when a user temporarily operates the load 700 before the output power of the battery 110 is reduced, a voltage change may occur in the DC link.

According to another embodiment, when a user temporarily operates the load 700 after the output power of the battery 110 is reduced, a voltage change may occur in the DC link.

Accordingly, the power control apparatus may detect changes in the voltage of the DC link by continuously monitoring the operating state of the load 700 and changes in output power of the battery 110.

Here, the operating state of the load 700 is controlled by user's actions, so it is difficult to predict in advance. Meanwhile, the PCS 400 provides output power equal to the power consumption of the load 700. Accordingly, the power control apparatus may detect changes in the operating state of the load 700 by continuously monitoring changes in output power of the PCS 400.

When a voltage change in the DC link occurs, the power control apparatus may compare the output power of the PCS 400 and the output power of the battery 110. In other words, the power control apparatus may compare the power consumption of the load 700 and the output power of the battery 110.

Accordingly, the power control apparatus may use the DC/DC converter 500 to control the size and speed of the output power of the battery 110 according to the comparison result (S5000). For example, DC/DC converter 500 may be a bidirectional converter.

How the power control apparatus controls the size and speed of the output power of the battery 110 through the DC/DC converter 500 will be described in more detail below.

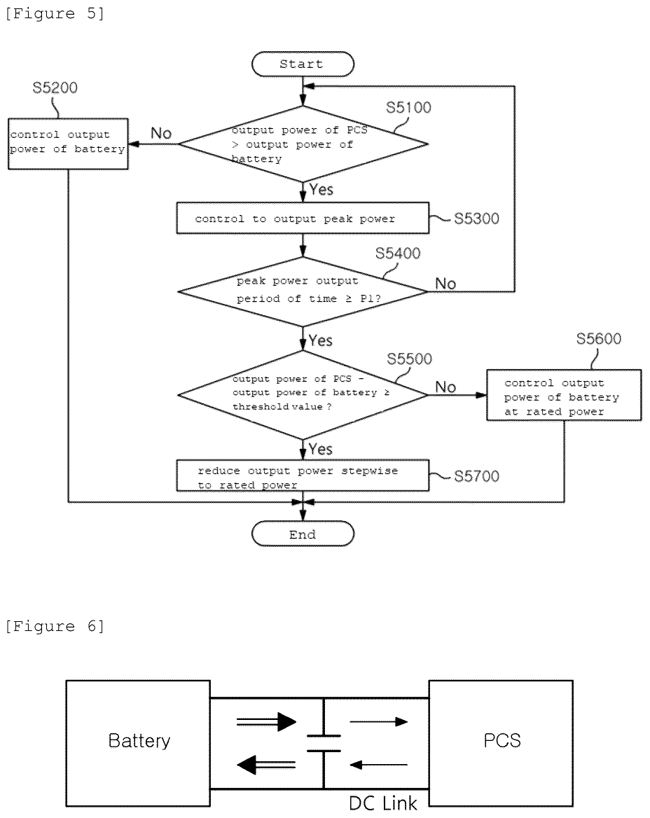

FIG. 5 is a flowchart for explaining the step of controlling the output power of the battery in the power control method according to embodiments of the present invention.

Referring to FIG. 5, the power control apparatus according to embodiments of the present invention may compare output power of the PCS 400 and output power of the battery 110 (S5100).

According to an embodiment, when the output power value of the PCS 400 is less than or equal to the output power value of the battery 110 (No in S5100), it may be determined that power consumption of the load 700 is reduced under user's control. Accordingly, the power control apparatus may control an amount of current of the DC/DC converter 500 (S5200) to quickly reduce the output power of the battery 110 at a higher speed than a predefined reference speed.

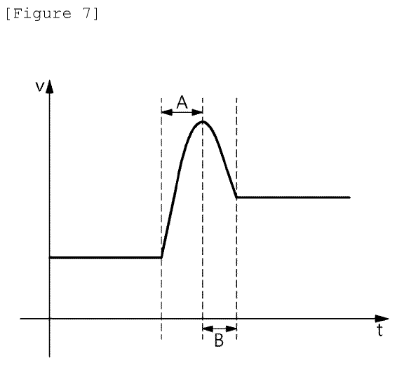

FIG. 6 is a block diagram for explaining a power control 1 method according to embodiments of the present invention. Additionally, FIG. 7 is a graph of voltage change over time in the DC link according to FIG. 6.

Referring to FIGS. 6 and 7, when the power consumption of the load 700 is reduced, the output power of the battery 110 is greater than the power consumption of the load 700, and thus, a voltage change of the DC link may occur (section A in FIG. 7).

Therefore, the power control apparatus may quickly reduce the output power of the battery 110 by controlling the amount of current of the battery 110 at a high speed using the DC/DC converter 500 (section B in FIG. 7). Accordingly, the voltage of the DC link can be stabilized.

Referring again to FIG. 5, according to another embodiment, when the output power value of the PCS 400 exceeds the output power value of the battery 110 (Yes in S5100), the power control apparatus may operate the DC/DC converter 500 to control the battery 110 to output peak power (S5300), so as to prepare for unexpected operation of the load 700.

In general, upon being powered, the load 700 may temporarily consume peak power and then consume a predefined rated power again. However, operation timing of the load 700 may not be predicted. Therefore, when the output power of the battery 110 becomes lower than the output power of the PCS 400, the power control apparatus according to embodiments of the present invention may first control the battery 110 to operate at peak power for a preset time. Here, the peak power of the battery 110 may be power provided from the battery 110 to support output power above the rated power that is temporarily generated at initial time when power is applied to the load 700. For example, the peak power may be 11 kw. However, since the load 700 is operated under a user's control, the power control apparatus cannot predict an operation time of the load. Additionally, since the battery 110 has limited charge capacity, the battery may provide maximum peak power only for a limited period of time.

According to an embodiment, when the peak power output period of time of the battery 110 is less than a preset first period (P₁) (No in S5400), the process returns to step S5100 and continuously monitors voltage changes in the DC link by comparing the output power of the PCS 400 and the rated power of the battery 110. For example, the first period (P₁) may be 9.6 sec.

Meanwhile, according to another embodiment, when the peak power output period of time of the battery 110 is equal to or longer than the preset first period of time (P₁) (Yes in S5400), the power control apparatus may compare difference between the output power of the PCS 400 and the output power of the battery 110 at the current time with a predetermined threshold value (S5500).

Here, when the difference between the output power of the PCS 400 and the output power of the battery 110 is less than the predetermined threshold value (No in S5500), the power control apparatus may determine that stable power supply, by the PCS 400, to the load 700 is possible. Accordingly, the power control apparatus may reduce the output power of the battery 110 to the rated power through the DC/DC converter 500 (S5600).

Meanwhile, when the difference between the output power of the PCS 400 and the output power of the battery 110 is equal to or greater than the predetermined threshold value (Yes in S5500), the power control apparatus may determine that stably supplying power to the load 700 solely with the output power of the PCS 400 is difficult. Accordingly, the power control apparatus may stepwise reduce the output power rate of the battery 110 by the DC/DC converter 500 in order to reduce control burden of the PCS 400 (S5700).

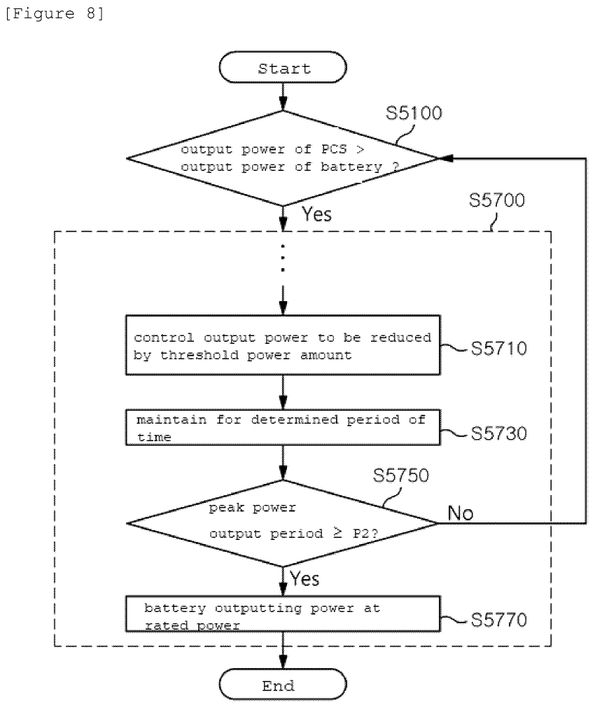

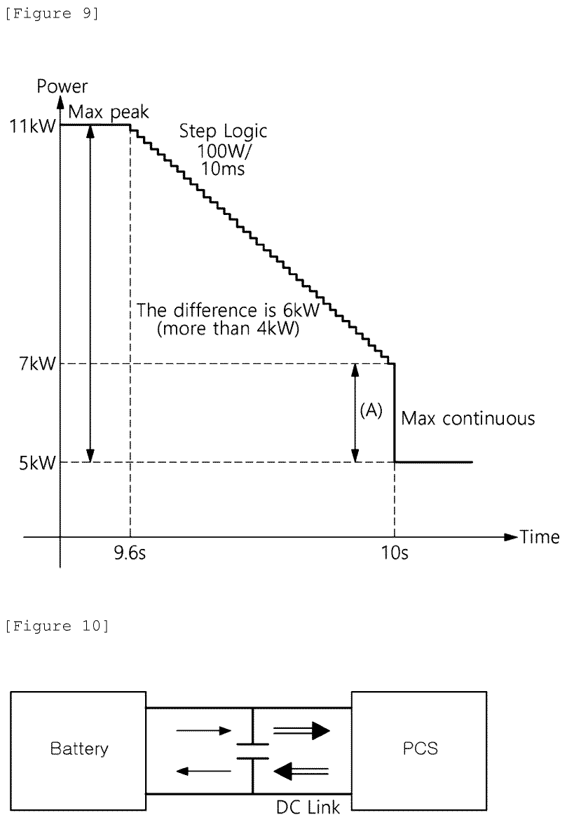

FIG. 8 is a flowchart to explain the step of controlling the output power of the battery stepwise in the power control method according to embodiments of the present invention. Additionally, FIG. 9 is a graph of battery output power control over time according to FIG. 8.

Referring to FIGS. 8 and 9, when the difference between the output power of the PCS 400 and the output power of the battery 110 is greater than or equal to a predetermined threshold value (Yes in S5500), the power control apparatus may control the DC/DC converter 500 to reduce the output power of the battery 110 by a predefined threshold power amount (S5710). Here, the predefined threshold power amount may be 100 W.

Thereafter, the power control apparatus may control the DC/DC converter 500 to maintain the output power of the battery 110 for a predetermined period of time (S5730). For example, the DC/DC converter 500 may maintain the output power reduced by the predefined threshold power amount for 10 ms.

In other words, the power control apparatus may gradually reduce the output power of the battery with a step logic through the DC/DC converter 500 by a predefined threshold power amount at each preset cycle.

Thereafter, the power control apparatus may compare the peak power output period with a second period of time (P₂) (S5750). Here, the second period of time (P₂) may be a threshold period during which the output power of the battery can be output at more than the rated power. For example, the second period (P₂) may be 10 seconds.

According to an embodiment, when the peak power output period of time of the battery 110 reaches the second period of time (P₂) (Yes in S5750), the power control apparatus may adjust the output power of the battery 110 to rated power (Max Continuous) through the DC/DC converter 500 (S5770). For example, the rated power of battery 110 may be 7 kW.

Here, the rated power may be preset to any one value within the output range of the rated power (see (A) in FIG. 7). In other words, the output range of the rated power may fall within the output power control range of the PCS 400 for stabilizing the voltage of the DC link. Accordingly, the power control apparatus may control the output power of the battery 110 by reducing the output power of the battery stepwise by the threshold power amount through the DC/DC converter 500 until the period of power control time reaches the second period of time (P₂).

Meanwhile, according to another embodiment, if the peak power output period of time of the battery 110 is not the same as the second period of time (P₂) (No in S5750), the power control apparatus may return to step S5100 and compare the output power of the PCS 400 and the output power of the battery, thereby continuously monitoring voltage changes in the DC link.

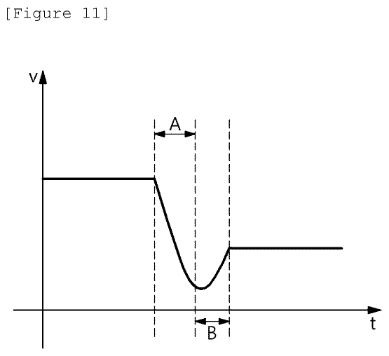

FIG. 10 is a block diagram for explaining a power control method according to another embodiment of the present invention. Furthermore, FIG. 11 is a graph of voltage change over time in the DC link according to FIG. 10.

Referring to FIGS. 10 and 11, as in step S5300 of FIG. 5, when the output power value of the battery 110 is smaller than the output power value of the PCS 400 (Yes in S5100), the power control apparatus may control the DC/DC converter 500 to operate the battery 110 at peak power (S5300), in order to prepare for a situation that the load 700 is unexpectedly operated by a user. Accordingly, when the load 700 is operated by a user within the peak power output period of the battery 110, the battery 110 may stably supply power despite temporary peak power consumption of the load 700.

Meanwhile, the power control apparatus gradually reduces the output of the peak power in preparation for the load 700 being operated after the peak power output period of the battery 110. Accordingly, when the load 700 is operated during the second period P₂ after the peak power output period of time of the battery 110, the power control apparatus may output the power of the battery 110 above the rated voltage, and thus, voltage fluctuations in the DC link (sections A and B in FIG. 11) can be minimized.

The power control apparatus and method according to embodiments of the present invention have been described above.

The power control apparatus and method according to embodiments of the present invention may monitor the output power of the PCS, detect changes in the voltage of the DC and control the output power of the battery by link, comparing the output power of the PCS with the rated power of the battery, and thus, provides stabilization of the energy storage system by preventing voltage fluctuations in the DC link.

The operations of the method according to the embodiments of the present invention may be implemented as a computer-readable program or code on a computer-readable recording medium. The computer-readable recording medium includes all types of recording devices in which data readable by a computer system is stored. In addition, the computer-readable recording medium may be distributed in a network-connected computer system and execute computer-readable programs or codes in a distributed manner.

In addition, the computer-readable recording medium may include hardware devices specially configured to store and execute program instructions, such as ROM, RAM, flash memory, etc. The program instructions may include not only machine language code created by a compiler, but also high-level language code that can be executed by a computer using an interpreter.

Although some aspects of the invention have been described in the context of the apparatus, it may also represent a description according to a corresponding method, wherein a block or apparatus corresponds to a method step or feature of a method step. Similarly, aspects described in the context of a method may also represent a feature of a corresponding block or item or a corresponding apparatus.

Some or all of the method steps may be performed by (or using) a hardware device, such as, for example, a microprocessor, a programmable computer, or an electronic circuit. In some embodiments, one or more of the most important method steps may be performed by such an apparatus.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1. A power control apparatus, which is connected to a converter performing Direct current/Direct current (DC/DC) conversion between a battery and a power conversion system (PCS), and configured to control output power of the battery, the apparatus comprising:
a memory; and
a processor executing at least one instruction in the memory,
wherein the at least one instruction includes:
an instruction to detect a voltage of a DC link between an input terminal of the PCS and an output terminal of the converter; and
an instruction to control the output power of the battery based on a change in output power of the PCS which in turn is in accordance with a change in the voltage of the DC link.

2. The apparatus of claim 1, wherein the instruction to control the output power of the battery includes an instruction to control the output power of the battery by controlling a current of the battery.

3. The apparatus of claim 1, wherein the instruction to control the output power of the battery includes an instruction to control the battery to output power with a predefined peak power value when the output power of the PCS exceeds the output power of the battery.

4. The apparatus of claim 3, wherein the instruction to control the battery to output power with the predefined peak power value includes:
an instruction to, upon a peak power output period of the battery being equal to or longer than a predefined first period of time, compare a difference between the output power of the PCS and the output power of the battery with a predefined threshold value; and
an instruction to control the battery to output power at a rated power in an instance that the difference is less than the predefined threshold value.

5. The apparatus of claim 3, wherein the instruction to control the battery to output power with the predefined peak power value includes:
an instruction to, upon a peak power output period of the battery being equal to or longer than a predefined first period of time, compare a difference between the output power of the PCS and the output power of the battery with a predefined threshold value; and
an instruction to control the battery to output power stepwise to a rated power in an instance that the difference is greater than or equal to the predefined threshold value.

6. The apparatus of claim 5, wherein the instruction to control the battery to output power stepwise to the rated power includes:
an instruction to control the battery to output power by reducing the output power stepwise by a threshold power amount during a predetermined second period of time based on a peak power of the battery.

7. The apparatus of claim 6, wherein the instruction to control the battery to output power stepwise to the rated power further includes:
an instruction to control the battery to output power at the rated power when the peak power output period exceeds the predefined second period of time.

8. A power control method performed by a power control apparatus, which is connected to a converter performing Direct current/Direct current (DC/DC) conversion between a battery and a power conversion system (PCS) and configured to control output power of the battery, the method comprising:
detecting a voltage of a DC link between an input terminal of the PCS and an output terminal of the converter; and
controlling the output power of the battery based on a change in output power of the PCS which in turn is in accordance with a change in the voltage of the DC link.

9. The method of claim 8, wherein the controlling the output power of the battery includes controlling the output power of the battery by controlling a current of the battery.

10. The method of claim 8, wherein the controlling the output power of the battery includes controlling the battery to output power with a predefined peak power value when the output power of the PCS exceeds a predefined rated power of the battery.

11. The method of claim 10, wherein the controlling the battery to output power with the predefined peak power value includes:
upon a peak power output period of the battery being equal to or longer than a predefined first period of time, comparing a difference between the output power of the PCS and the output power of the battery with a predefined threshold value; and
controlling the battery to output power at a rated power in an instance that the difference is less than the predefined threshold value.

12. The method of claim 10, wherein the controlling the battery to output power with the predefined peak power value includes:
upon a peak power output period of the battery being equal to or longer than a predefined first period of time, comparing a difference between the output power of the PCS and the output power of the battery with a predefined threshold value; and
controlling the battery to output power stepwise to a rated power in an instance that the difference is greater than or equal to the predefined threshold value.

13. The method of claim 12, wherein the controlling the battery to output power stepwise to the rated power includes:
controlling the battery to output power by reducing the output power stepwise by the threshold power amount during a predetermined second period of time based on a peak power of the battery.

14. The method of claim 13, wherein the controlling the battery to output power stepwise to the rated power includes:
controlling the battery to output power at the rated power when the peak power output period exceeds the predefined second period of time.

15. An energy storage system comprising:
a battery rack;
a plurality of converters configured to perform Direct current/Direct current (DC/DC) conversion in conjunction with the battery rack;
a power conversion system (PCS) connected to the DC/DC converter and a load; and
a power control apparatus connected to the DC/DC converter and configured to control an operation of the DC/DC converter,
wherein the plurality of converters are operated by the power control apparatus which is configured to detect a voltage of a DC link between an input terminal of the PCS and an output terminal of the converter and to control output power of the battery rack based on a change in output power of the PCS which in turn is in accordance with a change in the voltage of the DC link.

16. The system of claim 15, wherein the plurality of converters are operated, by the power control apparatus, to control the output power of the battery rack by controlling a current of the battery rack.

17. The system of claim 15, wherein the plurality of converters are operated, by the power control apparatus, to control the battery rack to output power with a predefined peak power value when the output power of the PCS exceeds a predefined rated power of the battery rack.

18. The system of claim 17, wherein the plurality of converters are operated, by the power control apparatus, to:
upon a peak power output period of the battery rack being equal to or longer than a predefined first period of time and a difference between the output power of the PCS and a rated power of the battery rack being less than of the predefined threshold value,
control the battery rack to output power at the rated power.

19. The system of claim 17, wherein the plurality of converters are operated, by the power control apparatus, to:
upon a peak power output period of the battery rack being equal to or longer than a predefined first period of time and a difference between the output power of the PCS and a rated power of the battery rack being equal to or greater or than the predefined threshold value,
control the battery rack to output power stepwise to the rated power.

20. The system of claim 19, wherein the plurality of converters are operated, by the power control apparatus, to:
control the battery rack to output power by reducing the output power stepwise by the threshold power amount during a predetermined second period of time based on a peak power of the battery rack.

21. The system of claim 20, wherein the plurality of converters are operated, by the power control apparatus, to:
control the battery rack to output power at the rated power when the peak power output period exceeds the predefined second period of time.
